(19) United States
(12) Patent Application Publication
(10) Pub. No.: US 2019/0191799 A1
(43) Pub. Date: Jun. 27, 2019

(54) SEAM SEALED HEAT RESISTANT GLOVE OR MITT

(71) Applicant: Wells Lamont Industry Group LLC, Niles, IL (US)

(72) Inventors: Timothy R. Hartigan, Wilmette, IL (US); Robert D. Foster, Miramar, FL (US)

(21) Appl. No.: 16/232,543

(22) Filed: Dec. 26, 2018

Related U.S. Application Data
(60) Provisional application No. 62/610,734, filed on Dec. 27, 2017.

(51) Int. Cl. A41D 19/015; B29C 65/50; B29C 65/08; B29C 65/00

(52) U.S. Cl. CPC A41D 19/01529; B29C 65/5057; B29C 65/08; B29C 66/4326; B29C 66/71; B29L 2031/4864; B29C 66/73921; A41D 2300/52; A41D 2400/60; A41D 2500/50; B29C 66/729

(57) ABSTRACT

A seam sealed heat resistant glove or mitt includes a front portion having a periphery and a rear portion having a periphery. The front and rear portions are joined to one another along a portion of their respective peripheries to define seams. The front and rear portions, when joined to one another, define an interior with seams formed at the interior and at an exterior of the glove or mitt with seams formed at the exterior. A welded thermoplastic material is disposed over the seams on at least one of the interior and the exterior of the glove or mitt and is cured by the application of ultrasonic energy. A method of making a seam sealed glove or mitt is disclosed.

### CROSS-REFERENCE TO RELATED APPLICATION DATA

This application claims the benefit of and priority to Provisional U.S. Patent Application Ser. 62/610,734, filed Dec. 27, 2017, titled Seam Sealed Heat Resistant Glove or Mitt.

### BACKGROUND

The present disclosure relates to a heat resistant glove or mitt (or mitten). Heat resistant hand protection wear, such as mittens (or mitts) and gloves are well known. While gloves provide a more dexterous fit, they can be complex to manufacture due to forming and stitching the palm and back, fingers, thumbs, fourchettes, quirks and other parts of the glove to conform to the user's hand. One-piece (non-stitched) gloves are also known, such as medical or household gloves, formed from latex or nitrile. However, these gloves are thinner and typically are used only to protect one's hands when using chemicals, cleaning, and the like.

Often, mittens or mitts will suffice when the dexterity of gloves is not needed. For example, oven mitts are used to protect the user's hand from hot surfaces such as pots, pans, their handles and the like. Such mitts are usually made from cotton or other fibrous materials (e.g., cotton interiors and exteriors) and have front and rear portions sewn together along a seam. Silicone mitts are also known that can be made without seams (e.g., one-piece) and can include a lining, such as a cotton lining for user comfort.

Gloves and mitts with cotton exteriors have drawbacks in that they can absorb water which can allow water ingress into the interior of the mitt (to potentially burn the user's hand), and can provide a medium for bacterial growth. In addition, steam or hot liquids may be able to enter along seams which can, again, potentially burn the user's hand.

While one-piece silicone gloves and mitts solve the problems associated with seams, special equipment is needed to form these items. In addition, the inclusion of linings can add complexity and costs to manufacturing such items.

Accordingly, there is a need for a heat-resistant protective glove or mitt. Desirably, such a glove or mitt is water resistant or waterproof, including along seams, and can include a lining for user comfort. More desirably still, such a glove or mitt is readily manufactured using known techniques.

### SUMMARY

Various embodiments of the present disclosure provide a seam sealed heat resistant glove or mitt. The glove or mitt has a front portion having a periphery and a rear portion having a periphery. The front and rear portions joined to one another along a portion of their respective peripheries to define seams, the front and rear portions, when joined to one another, defining an interior with seams formed at the interior and at an exterior of the glove or mitt,

A welded thermoplastic material is disposed over the seams on at least one of the interior and the exterior of the glove or mitt. In an embodiment, the welded thermoplastic material is a thermoplastic tape. The thermoplastic tape can be a polyurethane-based tape. In an embodiment the tape has a curable adhesive on a side thereof. The curable adhesive can be an ultrasonic energy cured adhesive. A cover layer can be present on a side of the tape opposite the adhesive.

In an embodiment, the front and rear portions are formed from a liquid impervious material. The material can be, for example, silicone. A liner can be provided on the material, such that the liner is positioned on an interior of the glove or mitt. The liner can be, for example, a cotton or cotton-blend material, a synthetic material or the like to enhance comfort.

A method of making a seam sealed heat resistant glove or mitt, includes stitching together a front portion of the glove or mitt and a rear portion of the glove or mitt. The front and rear portions each have a periphery. The front and rear portions are stitched together along a portion of their respective peripheries to define seams. The stitched front and rear portions define an interior surface of the glove or mitt and an exterior surface of the glove or mitt.

The method includes applying a sealing tape to the seams along one or both of the interior surface of the glove or mitt and the exterior surface of the glove or mitt and curing the sealing tape.

In an embodiment, the curing step is carried out using ultrasonic energy. The sealing tape can be applied to the seams along the interior surface and the exterior surface. In an embodiment, the front portion and the rear portion are formed from silicone. The front and rear portions can be formed from a lined material. In an embodiment, lined portion is a cotton, a cotton blend or a synthetic material.

These and other features and advantages of the present disclosure will be apparent from the following detailed description, in conjunction with the appended claims.

### BRIEF DESCRIPTION OF THE DRAWINGS

FIG. 1 is an illustration of an embodiment of a seam sealed heat resistant mitt;

FIG. 2 is another illustration of the mitt of FIG. 1, showing a portion of the inside of the mitt;

FIG. 3 is another illustration of the mitt of FIG. 1, showing the inside of the mitt;

FIG. 4 is another illustration showing a portion of the seam of an embodiment of mitt;

FIG. 5 is an illustration of an embodiment of the mitt showing a portion of the seam;

FIG. 6 is a schematic cross-sectional illustration of the material used to fabricate the mitt;

FIG. 7 is a schematic cross-sectional illustration of a seam that is sealed on the inside and the outside of the mitt; and

FIG. 8 is a schematic cross-sectional illustration of an example of a tape used to seal the seam of the mitt.

### DETAILED DESCRIPTION

While the present disclosure is susceptible of embodiments in various forms, there is shown in the drawings and will hereinafter be described a presently preferred embodiment with the understanding that the present disclosure is to be considered an exemplification and is not intended to limit the disclosure to the specific embodiment illustrated.

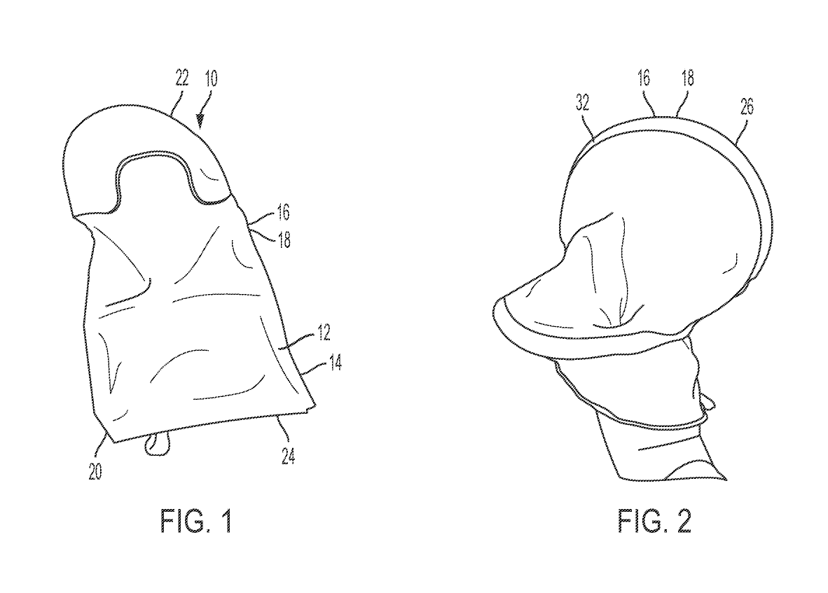

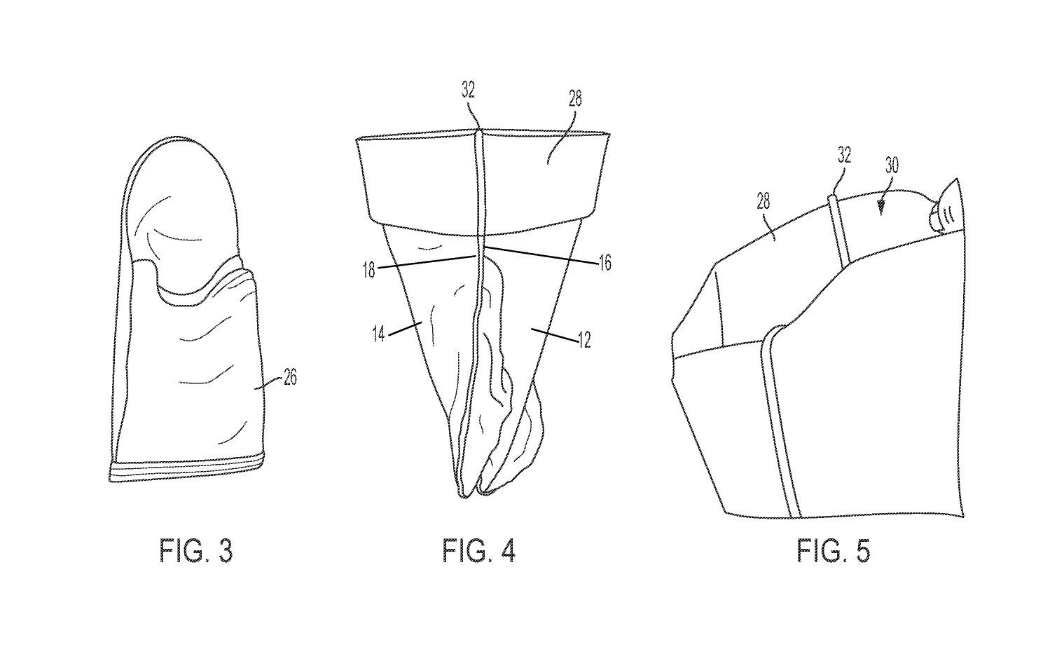

Referring now to the figures and in particular to FIG. 1 there is shown an embodiment of a seam sealed heat resistant mitt 10. In an embodiment, the mitt 10 is formed from a front portion 12 or palm and a rear portion or back 14. The front and rear portions 12, 14 are joined to one another, as by stitching, along a portion of their respective peripheries 16, 18 extending along an arm or upper wrist portion 20 and along the hand portions 22, leaving an opening 24 at the uppermost wrist (or arm) portion 20 for the user to put the mitt 10 on the user's hand. In an embodiment, the front and rear portions 12, 14 are mirror images of one another and as such, the mitt 10 can be worn on the user's left or right hand—that is, the mitt 10 is not hand specific. Alternately, the mitt 10 can be formed with the thumb portion centrally placed on the front 12 of the mitt 10, again so that the mitt 10 is not hand specific.

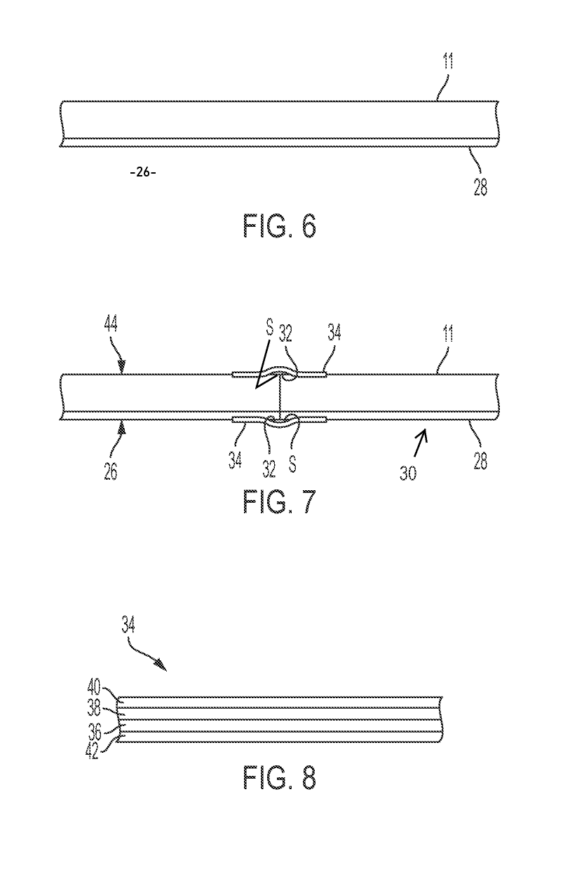

Referring to FIGS. 6-8, in an embodiment, the mitt is formed from a base material 11, such as silicone; other suitable materials will be recognized by those skilled in the art. The interior 26 of the mitt 10 can be covered or lined by a liner 28, such as a woven material, such as cotton or other suitable woven or non-woven material, to provide a comfortable feel and environment for the user's hand. One such example is illustrated in FIGS. 5 and 6, which shows a woven material forming a liner 28 on an inner surface 30 of the mitt 10. Such a liner 28 can absorb perspiration and the like, again providing a more comfortable user environment for the mitt.

As noted above, the front and rear portions 12, 14 are joined to one another, as by stitching along a portion of their respective peripheries 16, 18. FIGS. 4 and 5 illustrate one example of the front and rear portions 12, 14, which can be joined by a zigzag stitch S (see FIG. 7), with the interior side of one portion overlying the exterior side of the other portion. The stitch S is made across the front and rear portions 12, 14 to form a seam 32. Other types of stitching can also be used. It will be appreciated that although not shown, a glove is manufactured in a similar manner by forming seams by stitching along the respective peripheries of the front and rear portions of the glove, including along the fingers, thumb and fourchettes as needed, leaving the only non-stitched portion at the wrist or arm for a user to put on the glove.

The seam or seams 32 are sealed. In an embodiment, the seams 32 are sealed by a seal, such as a thermoplastic, sonic welded seam tape 34 applied to seal all seams 32. After the glove or mitt 10 is assembled (stitched), a tape 34 is applied to the seams 32. In an embodiment, the tape 34 is a thermoplastic-based material, such as a polyurethane based tape having an ultrasonic cured adhesive. As illustrated in FIG. 8, in an embodiment, the tape 34 is a two-layer polyurethane tape (layers 36, 38) having a polyamide adhesive 40 on a side of one of the polyurethane layers 38. In an embodiment, the tape 34 can have a layer, e.g., a cover layer 42 of another, different material applied thereto on the side opposite the adhesive 40. One suitable material for the cover layer 42 is a nylon surface layer, for example a nylon 6/6 surface layer. A suitable tape is TAF-920 seam sealing tape commercially available from Adhesive Films, Inc., of Pine Brook, N.J.

Ultrasonic energy is then applied to the tape 34 over the seams 32. The ultrasonic energy effectively welds the tape 34 to the glove or mitt 10 material to form a liquid and steam impermeable seal over the seams 32. The taping and sealing is carried out on the seams 32 on either or both the interior 26 and exterior 44 of the glove or mitt 10. It is also contemplated that the seams 32 can be sealed using a liquid applied material. For example, silicone or another suitable material that withstands heat, may be applied to the seams 32 to effect a seal. When used in the food industry it is contemplated that a material that withstands heat and that is safe for food contact can be used.

An embodiment of a method of making a seam sealed heat resistant glove or mitt 10 includes stitching front and rear portions 12, 14 of the mitt 10 extending along the arm 20 or upper wrist portion and along the hand portions 22 (or front and rear portions of the glove, including along the fingers, thumb and fourchettes as needed, and extending along the arm or upper wrist portion) to one another along respective peripheries 16, 18, to define seams 32, leaving an opening 24 at the uppermost wrist (or arm) portion 20. The stitching S can be zigzag stitching. Other types of stitching can also be used.

The method includes applying a tape 34, such as a thermoplastic tape, for example, a polyurethane based tape having two layers 36, 38, a polyamide adhesive 40 and a top or cover layer 42 (opposite the adhesive 40) of a different material such as a nylon, for example, nylon 6/6, along all of the stitched seams 32. The tape 34 can be applied along the seams 32 on the interior 26 of the glove or mitt 10, the exterior 44 of the glove or mitt 10 or the seams 32 on both the interior 26 and the exterior 44 of the glove or mitt 10. The method includes subjecting the tape 34 to ultrasonic energy to, in effect, weld the tape 34 to the glove or mitt 10 material adjacent to and in or on the seams 32 to form a liquid and steam impermeable seal over the seams 32.

It has been found that a seam sealed glove or mitt 10 improves the protective features of these products in kitchen applications where moisture and steam are often present. The sealed seams 32 help to prevent damp areas that may lead to bacterial growth on the inside of the gloves and mitts 10 where absorbing materials (e.g., cotton linings 28) may be present. The sealed seams 32 also aid in enhancing cleaning techniques used for these products in that they can be rinsed in a sink without saturating the inside 26 of the glove or mitt 10, especially when using a liner 28 formed from a cotton or other absorbent material. These features, along with the unique combination of fabric selection and seam 32 sealing, can prolong the life of the product in its typical application. Such features include, for example, liquid impermeable materials as the base material 11, seam sealed tape 34 that is added over sewn seams 32 and complete coverage of seams 32 so that the glove or mitt 10 is fully waterproof.

In the present disclosure, the words “a” or “an” are to be taken to include both the singular and the plural. Conversely, any reference to plural items shall, where appropriate, include the singular. All patents and published applications referred to herein are incorporated by reference in their entirety, whether or not specifically done so within the text of this disclosure.

It will also be appreciated by those skilled in the art that the relative directional terms such as sides, upper, lower, top, bottom, rearward, forward and the like are for explanatory purposes only and are not intended to limit the scope of the disclosure.

From the foregoing it will be observed that numerous modifications and variations can be effectuated without departing from the true spirit and scope of the novel concepts of the present disclosure. It is to be understood that no limitation with respect to the specific embodiments illustrated is intended or should be inferred. The disclosure is intended to cover by the appended claims all such modifications as fall within the scope of the claims.

What is claimed is:

1. A seam sealed heat resistant glove or mitt, comprising:
a front portion having a periphery;
a rear portion having a periphery, the front and rear portions joined to one another along a portion of their respective peripheries to define seams, the front and rear portions, when joined to one another, defining an interior with seams formed at the interior and at an exterior of the glove or mitt; and
a welded thermoplastic material disposed over the seams on at least one of the interior and the exterior of the glove or mitt.

2. The glove or mitt of claim 1, wherein the front and rear portions are formed from a liquid impervious material.

3. The glove or mitt of claim 2, wherein the material is silicone.

4. The glove or mitt of claim 2 including a liner on the material, wherein the mitt or glove, when formed, has the liner positioned on an interior of the glove or mitt.

5. The glove or mitt of claim 4 wherein the liner is a cotton or cotton-blend material.

6. The glove or mitt of claim 4 wherein the liner is a synthetic material.

7. The glove or mitt of claim 2, wherein the welded thermoplastic material is a thermoplastic tape.

8. The glove or mitt of claim 7 wherein the thermoplastic tape is a polyurethane-based tape.

9. The glove or mitt of claim 8 wherein the tape has a curable adhesive on a side thereof.

10. The glove or mitt of claim 9 wherein the curable adhesive is an ultrasonic energy cured adhesive.

11. The glove of mitt of claim 9 including a cover layer on a side of the tape opposite the adhesive.

12. A method of making a seam sealed heat resistant glove or mitt, comprising
stitching together a front portion of the glove or mitt and a rear portion of the glove or mitt, the front and rear portions each having a periphery, the front and rear portions being stitched together along a portion of their respective peripheries defining seams, the stitched front and rear portions defining an interior surface of the glove or mitt and an exterior surface of the glove or mitt;
applying a sealing tape to the seams along one or both of the interior surface of the glove or mitt and the exterior surface of the glove or mitt; and
curing the sealing tape.

13. The method of claim 12, wherein the curing step is carried out using ultrasonic energy.

14. The method of claim 12, wherein the sealing tape is applied to the seams along the interior surface and the exterior surface.

15. The method of claim 12 wherein the front portion and the rear portion are formed from silicone.

16. The method of claim 12 wherein the front portion and the rear portion are formed from a lined material.

17. The method of claim 16 wherein the material is silicone and the lined portion is a cotton, a cotton blend or a synthetic material.
